(19) United States
(12) Patent Application Publication
(10) Pub. No.: US 2015/0228965 A1
(43) Pub. Date: Aug. 13, 2015

(54) NEGATIVE ELECTRODE FOR A SECONDARY BATTERY, A SECONDARY BATTERY, A VEHICLE AND A BATTERY-MOUNTED DEVICE

(71) Applicant: TOYOTA JIDOSHA KABUSHIKI KAISHA, Toyota-shi, Aichi (JP)

(72) Inventors: Shin Ushiroda, Susono-shi (JP); Makio Kon, Mishima-shi (JP)

(73) Assignee: TOYOTA JIDOSHA KABUSHIKI KAISHA, Toyota-shi (JP)

(21) Appl. No.: 14/427,587

(22) PCT Filed: Sep. 25, 2013
(86) PCT No.: PCT/JP2013/005659

§ 371 Date: Mar. 11, 2015

(30) Foreign Application Priority Data
Sep. 28, 2012 (JP) 2012-216931

(51) Int. Cl. H01M 4/136; H01M 4/58; C01B 33/24; H01M 4/66; C01B 33/32; H01M 10/054; H01M 4/62

(52) U.S. Cl. CPC H01M 4/136; H01M 10/054; H01M 4/5825; H01M 4/623; H01M 4/662; H01M 4/625; C01B 33/32; C01B 33/24; H01M 2220/20; H01M 2004/027

(57) ABSTRACT

The present invention provides a negative electrode for a secondary battery having a higher capacity than conventional batteries and the secondary battery having the negative electrode incorporated therein. The negative electrode for the secondary battery includes a silicate having a pyroxene structure and represented by a general formula AₚM₂₋ₚX₂O₆, wherein “A” represents at least one species selected from among a group of Na, Ca, Fe, Zn, Mn and Mg, “M” represents at least one species selected from among a group of transition metal elements, Al and Mg, where one of the transition metal elements being an indispensable element of “M”, “A” and “M” represent same elements or different elements, “p” represents a number satisfying 0<p<2, “X₂” represents Si₂ or Al_{q}Si_{2-q}, and “q” represents a number satisfying 0<q<2.

### TECHNICAL FIELD

The present invention relates to a negative electrode for a battery, a battery having the negative electrode for the battery incorporated therein and a vehicle and a battery-mounted device having the battery mounted thereon.

### BACKGROUND ART

In recent years, a lithium-ion battery has been rapidly wide spread as a secondary battery. The lithium-ion secondary battery is essentially composed of a positive electrode, a negative electrode, a separator and an electrolyte. The lithium-ion secondary battery is constructed to have the lithium-ion in the electrolyte move back and forth between the positive electrode and the negative electrode, thereby to charge and discharge.

As the negative electrode material, carbon materials, capable of providing a high capacity, have been practically used. However, the carbon materials have a drawback of being small in a specific gravity, and it is generally known that there is left only a small room of research for further improvement in the carbon materials.

In view of the above-mentioned problem, there have been proposed various kinds of negative electrode materials for the purpose of realizing a higher capacity. For example, there is proposed lithium titanate (Li₄Ti₅O₁₂) as a titanium oxide (See Patent Document 1 and Non-Patent Document 1, for example).

Further, there is proposed silicon oxide, represented by a general formula SiO_{y} (2>y>0) or LiₓSiO_{y} (x>0, 2>y>0) (See Patent Document 2 and 3 for example).

### CITATION LIST

### Patent Literature

Patent Document 1: Japanese Patent Application Publication No. 2001-126727
Patent Document 2: Japanese Registered Patent No. 2997741
Patent Document 3: Japanese Patent Application Publication No. 2012-054220

### Non-Patent Literature

Non-Patent Document 1: S. Y. Yin et al, “Synthesis of spinel Li4Ti5O12 anode material by a modified rheological phase reaction”, Electrochimica Acta, 2009, 54, 5629-5633

### SUMMARY OF INVENTION

### Technical Problem

However, there is a demand for a secondary battery of higher capacity than conventional batteries to be used as a drive power source mounted in portable electronic devices, such as for example, a notebook computer, a mobile telephone, or a video camera, and electric vehicles.

The present invention is made to solve such a problem, and has an object to provide a negative electrode for a battery capable of providing a secondary battery having a higher capacity than conventional secondary batteries and a battery having the negative electrode incorporated therein.

### Solution to Problem

The present inventors have made diligent studies to solve the above-mentioned technical problem, and found out that the use of a specific silicate mineral having a pyroxene structure as a negative electrode material of a secondary battery can lower a charge/discharge potential of the secondary battery and obtain the secondary battery having a higher capacity, compared to a case in which a conventional lithium titanate is used, thereby to complete the present invention.

The negative electrode for the battery according to the present invention comprises a silicate having a pyroxene structure and represented by a general formula AₚM₂₋ₚX₂O₆, wherein “A” represents at least one species selected from among a group consisting of Na, Ca, Fe, Zn, Mn and Mg, “M” represents at least one species selected from among a group consisting of transition metal elements, Al and Mg, where one of the transition metal elements being an indispensable element of “M”, “A” and “M” represent same elements or different elements, “p” represents a number satisfying 0<p<2, “X₂” represents Si₂ or Al_{q}Si_{2-q}, and “q” represents a number satisfying 0<q<2.

Further, the negative electrode for the battery according to the present invention is the above-mentioned negative electrode for the battery, wherein both of a charge capacity and a discharge capacity in a counter electrode lithium evaluation are 200 mAh/g or higher at an initial charge time and at an initial discharge time.

In addition, the negative electrode for the battery according to the present invention has a plateau potential being 1.5 V or lower at the initial charge time in the counter electrode lithium evaluation.

Furthermore, in the negative electrode for the battery according to the present invention, the silicate is one substance selected from among a group consisting of aegirine (NaFeSi₂O₆), esseneite (CaFeAlSiO₆) and augite [Ca(Mn, Fe, Zn)Si₂O₆].

In addition, the negative electrode for the battery according to the present invention includes two layers of a cupper foil and a negative electrode mixture, the two layers formed by coating the negative electrode mixture in a slurry state on the cupper foil and drying thereafter, wherein the negative electrode mixture in the slurry state is prepared by obtaining an active material through crushing the one substance and mixing the active material with N-methyl-2-pyrrolidone (NMP), in such a manner that a mass ratio of the active material, a conductive material (a carbon material) and polyvinylidene fluoride (PVDF) is 64:30:6.

Still further, a battery according to the present invention comprises the above-mentioned negative electrode for the battery.

Further, a vehicle according to the present invention has the above-mentioned battery mounted thereon.

Furthermore, a battery-mounted device according to the present invention has the above-mentioned battery mounted therein.

### Advantageous Effects of Invention

The present invention provides the negative electrode for the battery capable of providing a secondary battery having higher capacity than conventional secondary batteries and a battery having the negative electrode incorporated therein.

### BRIEF DESCRIPTION OF THE DRAWINGS

FIG. 1 is a schematic diagram showing a pyroxene structure of a silicate utilized in the present invention.

FIG. 2 is a schematic perspective view showing an external appearance of a lithium-ion secondary battery according to embodiments.

FIG. 3 is an A-A sectional view of FIG. 2.

FIG. 4 is a schematic perspective view showing a wound electrode body of FIG. 3.

FIG. 5 shows capacity-potential curves at a charge time and a discharge time in a counter electrode lithium evaluation using aegirine according to the first embodiment.

FIG. 6 shows capacity-potential curves at a charge time and a discharge time in a counter electrode lithium evaluation using esseneite according to the second embodiment.

FIG. 7 shows capacity-potential curves at a charge time and a discharge time in a counter electrode lithium evaluation using augite according to the third embodiment.

FIG. 7 shows capacity-potential curves at a charge time and a discharge time in a counter electrode lithium evaluation using lithium titanate according to the examples for comparison.

FIG. 9 shows capacity-potential curves at a charge time and a discharge time in a counter electrode sodium evaluation using aegirine according to the fourth embodiment.

FIG. 10 shows capacity-potential curves at a charge time and a discharge time in a counter electrode sodium evaluation using esseneite according to the fifth embodiment.

### DESCRIPTION OF EMBODIMENTS

### A Negative Electrode for a Battery

A negative electrode for a battery according to the present invention comprising a silicate having a pyroxene structure and represented by a general formula AₚM₂₋ₚX₂O₆ will be explained hereinafter. The negative electrode for the battery according to the present invention comprises a specific silicate as mentioned above.

Hereinafter, the specific silicate of the negative electrode for the battery according to the present invention will be simply referred to as “the silicate used in the present invention”.

The silicate used in the present invention is defined to be a substance which is expressed by the above-mentioned general formula and has the pyroxene structure among substances that are classified as silicate. The silicate used in the present invention can be a synthetic product or a natural product. The silicate used in the present invention can be generally obtained as a silicate mineral which is a natural product.

The silicate which is a natural product among the silicate used in the present invention will be hereinafter simply referred to as “a silicate mineral used in the present invention”.

The silicate mineral used in the present invention is classified as a pyroxene group of inosilicate mineral. Further, the silicate mineral used in the present invention refers to a pyroxene within a specific range among a pyroxene, as expressed by the above-mentioned general formula. The silicate used in the present invention is used in the negative electrode for the battery of the present invention as a negative electrode active material.

In the above-mentioned general formula, “A” represents one or more elements selected from among a group consisting of Ca, Fe, Mg, Mn, Na and Zn.

In the above-mentioned general formula, “M” represents a transition metal element. The transition metal element is an element belonging to groups 3 to 12 of the periodic table. The group 12 of the periodic table is classified as a transition metal in the present invention, although the group 12 of the periodic table is from time to time classified as a typical metal (Kagaku Daijiten (Encyclopedic Dictionary of Chemistry), 1st Edition (Tokyo Kagaku Dozin Co., Ltd.)). To be more specific, “M” represents, for example, one or more elements selected from among a group consisting of Cr, Fe, Mn, Sc, Ti, V and Zn.

Elements of different atomic value, for example Fe′ and Fe³⁺, may coexist in “A” and “M”.

“A” and “M” may represent same elements or different elements. “A” and “M” can represent the same elements, for example, in a case of ferrosilite or clinoferrosilite to be explained hereinafter.

In a relationship between “A” and “M”, a value of “p” can be within a range satisfying 0<p<2. The silicate used in the present invention can be complicated in structure and can be a mineral of natural product, so that the value of “p” cannot be specified any further. The value of “p” can be, for example, within a range from 0.9 to 1.1.

In a case the silicate mineral to be used in the present invention is used, a small quantity of other elements allowable as a natural mineral can be mixed in “A” and “M”.

In the above-mentioned general formula, “X₂” represents Si₂ or Al_{q}Si_{2-q}. In a case that “X₂” includes Si and Al, a value of “q” is within a range satisfying 0<q<2. The silicate used in the present invention can be complicated in structure and can be a mineral of natural product, so that the value of “q” cannot be specified any further. The value of “q” can be, for example, within a range from 1.4 to 1.6.

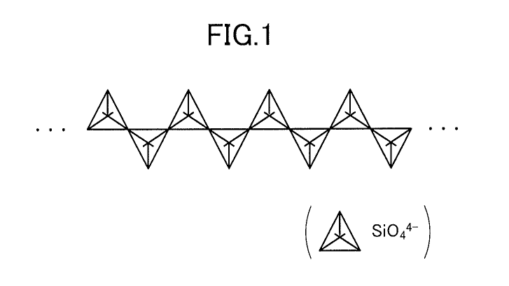

The pyroxene structure will be explained hereinafter with reference to FIG. 1. The silicate used in the present invention has the pyroxene structure as mentioned above. The pyroxene structure refers to a structure in which pluralities of SiO4 tetrahedrons, each sharing two oxygen atoms, are linked in a straight chain. This means that the pyroxene structure has a fundamental repeating unit of [(SiO₃)²⁻]. The pyroxene structure is a straight chain structure in which a plurality of SiO₄ tetrahedrons appear structured in a staggered alignment when viewed from a specific angle. The pyroxene structure can be confirmed by means of an X-ray diffraction (XRD) or the like.

Elements represented by “A” and “M” are accommodated in two apertures formed by a [(SiO₃)²⁻]₂ octahedron, respectively. The aperture accommodating A is formed by an apex of the SiO₄ tetrahedron and edges of the SiO₄ tetrahedron. The aperture for accommodating A, which is the most important aperture for the purpose of fastening the SiO₄ chain, is an extremely efficient flexible aperture. However, the aperture accommodating A has such a property that, when accommodated, a bonding force of an ionic bond of the silicate used in the present invention is dispersed, thus weakening the bonding force. On the other hand, the aperture for accommodating M is formed by one and another apex of the SiO₄ tetrahedron. The aperture accommodating M has a function to compensate for the bonding force weakened due to the aperture for accommodating A being accommodated by A.

Even though the pyroxene of natural product is classified into orthopyroxene and clinopyroxene based on the crystal structure, the silicate used in the present invention can be either one of the orthopyroxene and the clinopyroxene.

As can be understood from the foregoing description, the silicate used in the present invention can be either one of the synthetic product and the natural product. As the silicate used in the present invention, examples include: Mg—Fe pyroxene that are silicate minerals such as ferrosilite (Fs) [Fe²⁺₂Si₂O₆/(Fe²⁺, Mg)₂Si₂O₆], clinoferrosilite [Fe²⁺₂Si₂O₆/(Fe²⁺, Mg)₂Si₂O₆], pigeonite [(Mg, Fe²⁺, Ca)(Mg, Fe²⁺)Si₂O₆] and the like; and the synthetic products corresponding thereto.

In addition, as the silicate used in the present invention, examples include Mn—Mg pyroxene that are silicate minerals such as Kanoite [(Mn, Mg)₂Si₂O₆] and the synthetic products corresponding thereto.

Further, as the silicate used in the present invention, examples include: Ca pyroxene that are silicate minerals such as Hedenbergite (Hd) [CaFe²⁺Si₂O₆], augite [(Ca, Mg, Fe)₂Si₂O₆/(Ca, Na)(Mg, Fe, Al, Ti)(Si, Al)O₆/Ca(Mn, Fe, Zn)Si₂O₆], Johannsenite (Jo) [CaMnSi₂O₆], Petedunnite (Pe) [CaZnSi₂O₆/Ca(Zn, Mn²⁺, Fe²⁺, Mg)Si₂O₆], esseneite (Es) [CaFe³⁺AlSiO₆], davisite [CaScAlSiO₆], grossmanite [CaTi³⁺AlSiO₆], kushiroite [CaAlAlSiO₆] and the like; and the synthetic products corresponding thereto.

Furthermore, as the silicate used in the present invention, examples include: the pyroxene group of silicate minerals that are Ca—Na pyroxene such as omphacite [(Ca, Na)(Mg, Fe²⁺, Al, Fe³⁺)Si₂O₆/(Ca, Na)(Mg, Fe²⁺, Al)Si₂O₆], aegirine-augite [(Ca, Na)(Fe³⁺, Mg, Fe²⁺)Si₂O₆]; and the synthetic products corresponding thereto.

Still further, as the silicate used in the present invention, examples include a pyroxene group of the silicate mineral that are Na pyroxene such as jadeite (Jd) [Na(Al, Fe³⁺)Si₂O₆], aegirine (Ae) or acmite [NaFe³⁺Si₂O₆], kosmochlor (Ko) [NaCr³⁺Si₂O₆], jervisite (Je) [NaSc³⁺Si₂O₆/(Na, Ca, Fe²⁺)(Sc, Mg, Fe²⁺)Si₂O₆], mamansilite [NaMn³⁺Si₂O₆], natalyite or natalia pyroxene [Na(V³⁺, Cr³⁺) Si₂O₆] and the like; and the synthetic products corresponding thereto.

A country of origin as the silicate mineral used in the present invention is not particularly restricted. As the silicate mineral used in the present invention, for example, the silicate mineral originated in Malawi, Canada, Russia, the United States of America, Australia, the Czech Republic, France, Madagascar, South Africa, Namibia, Kenya, El Salvador, Saint Vincent and the Grenadines, French Southern and Antarctic Lands, Afghanistan, Algeria, Angola, Antarctica, Argentina, Armenia, Austria, Azerbaijan, Belarus, Bolivia, Brazil, Bulgaria, Myanmar, Cameroon, Central African Republic, The British Channel Islands, Egypt, Eritrea, Fiji, Finland, Chile, China, Colombia, Costa Rica, Congo, Ethiopia, French Polynesia, French West Indies, Germany, Ghana, Greece, Greenland, Guatemala, Guinea, Guyana, Honduras, Hungary, Iceland, India, Iran, Iraq, Ireland, Israel, Italy, Japan, Kazakhstan, Kyrgyzstan, Libya, Mali, Malta, Mexico, Montserrat, Mongolia, Morocco, New Caledonia, New Zealand, Niger, Nigeria, North Korea, Norway, Oman, Pakistan, Papua New Guinea, Paraguay, Peru, Poland, Portugal, Macedonia, France Territory Reunion Island, Romania, Saint Lucia, Sierra Leone, St. Helena, Saudi Arabia, Slovakia, Solomon Islands, South Korea, Somali Land, Spain, Sweden, Switzerland, Tajikistan, Tanzania, Turkey, the United States Virgin Islands, Uganda, the United Kingdom, Ukraine, Uzbekistan, Western Sahara, Yemen, Venezuela, Vietnam, Zambia and the like can be used.

To be specific, as the aegirine to be used in the present invention, for example, the aegirine originated in Malawi, Canada, Russia, Australia, the United States of America, Afghanistan, Algeria, Angola, Antarctica, Argentina, Armenia, Austria, Belarus, Bolivia, Brazil, Bulgaria, Myanmar, Cameroon, The British Channel Islands, Czech Republic, Chile, China, Congo, Ethiopia, France, French Polynesia, Germany, Greece, Greenland, Guatemala, Guinea, Guyana, Honduras, Hungary, Iceland, India, Italy, Japan, Kazakhstan, Kenya, Kyrgyzstan, Libya, Madagascar, Mali, Mexico, Mongolia, Morocco, Namibia, New Zealand, Niger, Nigeria, North Korea, Norway, Pakistan, Paraguay, Peru, Poland, Portugal, Macedonia, France Territory Reunion Island, Romania, St. Helena, Saudi Arabia, Slovakia, Somaliland, South Africa, Spain, Sweden, Switzerland, Tajikistan, Tanzania, Turkey, Uganda, the United Kingdom, Ukraine, Venezuela, Vietnam, Zambia and the like can be used.

As the esseneite to be used in the present invention, for example, the esseneite originated in Czech Republic, France, Russia, Israel, Italy, the United States of America and the like can be used.

As the augite to be used in the present invention, for example, the augite originated in the United States of America, Canada, Russia, Australia, Madagascar, South Africa, Namibia, Kenya, El Salvador, Saint Vincent and the Grenadines, French Southern and Antarctic Lands, Algeria, Antarctica, Argentina, Armenia, Austria, Azerbaijan, Bolivia, Brazil, Bulgaria, Cameroon, Central African Republic, Chile, China, Colombia, Costa Rica, Czech Republic, Egypt, Eritrea, Fiji, Finland, France, French Polynesia, French West Indies, Germany, Ghana, Greece, Greenland, Guatemala, Guinea, Hungary, Iceland, India, Iran, Iraq, Ireland, Israel, Italy, Japan, Kazakhstan, Kyrgyzstan, Libya, Mali, Malta, Mexico, Montserrat, Morocco, New Caledonia, New Zealand, Norway, Oman, Pakistan, Papua New Guinea, Paraguay, Poland, Portugal, Congo, Romania, Saint Lucia, Sierra Leone, Slovakia, Solomon Islands, South Korea, Spain, Sweden, Switzerland, Tanzania, Turkey, the United States Virgin Islands, the United Kingdom, Ukraine, Uzbekistan, Western Sahara, Yemen and the like can be used.

The synthetic products used in the present invention can be manufactured, for example, by a method recited in a reference literature (Alain DECARREAU et al, “Hydrothermal synthesis of aegirine at 200° C.”, European Journal of Mineralogy, 2004, 16, 85-90).

The silicate used in the present invention is usually used for the negative electrode material in a granulated form. The silicate can be granulated by appropriately employing known methods such as grinding in a mortar.

The granulated silicate to in the present invention can be used for the negative electrode material as it is without applying a further process such as heat treatment.

Further, the granulated silicate used in the present invention can be used with carbon coating applied on its surface for the purpose of improving electric conductivity or the like. The surface of the granulated silicate to be used in the present invention can be applied with carbon coating by appropriately employing known methods. The silicate with carbon coating applied on its surface can be obtained, for example, by dipping the granulated silicate into an aqueous solution inclusive of carbon source, stirring the aqueous solution, and thereafter drying and then firing under a reducing atmosphere to have the carbon source carbonized. Weight of carbon with respect to the silicate is not particularly restricted. For example, carbon can be 1-3 pts.mass per 100 pts.mass of the silicate. The carbon source to be used for carbon coating is not particularly restricted. Examples include polyvinyl alcohol, sucrose and the like.

(Structure of the Negative Electrode)

The structure of the negative electrode for the battery according to the present invention will be described hereinafter. The structure of the negative electrode for the battery according to the present invention is not particularly restricted except for using the silicate used in the present invention as a negative electrode active material. Any known structure of negative electrode can be employed for the negative electrode for the battery according to the present invention. The negative electrode for the battery according to the present invention is generally structured to include the negative electrode active material, a conductive material, a binding material and a negative electrode collector, but the negative electrode for the battery according to the present invention is not particularly restricted thereto.

(Negative Electrode Active Material)

The negative electrode active material used in the present invention must include the silicate to be used in the current invention, but may also include other kind of negative electrode active material as well. The other kind of negative electrode active material is not particularly restricted, but, for example, a carbon material partially including a graphite structure can be used as the other kind of negative electrode active material.

In a case that the silicate used in the present invention and the other kind of negative electrode active material are used in combination, a content of the silicate used in the present invention with respect to the negative electrode active material in its entirety is not particularly restricted, but it can be, for example, mass percentage of 50%-100%. The negative electrode active material may substantially be constituted alone by the silicate used in the present invention.

(Conductive Material)

The conductive material is not particularly restricted, but a carbon powder which is a carbon material and a conductive powder material which is such as a carbon fiber or the like are generally used as the conductive material used in the resent invention. The carbon powder is not particularly restricted. Examples include carbon black, including acetylene black, furnace black, Ketjen black or the like, and a graphite powder and the like. A content of the conductive material is not particularly restricted, but it can be, for example, 0.1-50 pts.mass with respect to the negative electrode active material 100 pts.mass. These conductive materials can be used alone by one kind thereof or in combination of two or more kinds thereof.

(Binding Material)

The binding material is not particularly restricted, but, for example, an organic solvent-soluble binding material, a water-dispersible binding material or the like can be used as the binding material.

Examples of the organic solvent-soluble binding material include polyvinylidene fluoride (PVDF), polyvinylidene chloride (PVDC), polyethylene oxide (PEO), polypropylene oxide (PPO), polyethylene oxide-propylene oxide copolymer (PEO-PPO), polyimide, polytetrafluoroethylene, polyethylene, polypropylene, polyvinyl pyrrolidone, polyester resins, acrylic resins, phenolic resins, epoxy resins and the like.

Examples of the water-dispersible binding material include: rubbers, such as styrene-butadiene rubber (SBR), acrylic resin-modified SBR (SBR latex), ethylene-propylene-diene copolymer resins, polybutadiene, acacia and fluorine rubber; fluorine-based resin, such as polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE); and the like.

A content of the binding material is not particularly restricted, but it can be appropriately adjusted according to a type and amount of the negative electrode active material. The content of the binding material can be, for example, 0.1-33 pts.mass or 0.1-10 pts.mass with respect to the negative electrode active material 100 pts.mass. These binding materials can be used alone by one kind thereof or in combination of two or more kinds thereof.

(Thickening Agent)

A thickening agent can be used in the negative electrode for the battery according to the present invention, as necessary. Examples of the thickening agent include cellulose resins such as carboxymethylcellulose (CMC), methyl cellulose (MC), cellulose acetate phthalate (CAP), hydroxypropyl methyl cellulose (HPMC), hydroxypropyl methylcellulose phthalate (HPMCP), and the like.

(Negative Electrode Collector)

The negative electrode collector is not particularly restricted, but, for example, a copper or an alloy consisting mainly of copper can be used as the negative electrode collector. A shape of the negative electrode collector, which varies depending on the shape of the secondary battery or the like, is not particularly restricted, but the negative electrode collector can take various forms such as rod-like shape, plate shape, sheet shape, foil shape and mesh shape.

(Method of Manufacturing the Negative Electrode)

A method of manufacturing the negative electrode for the battery according to the present invention will be explained hereinafter. The method of manufacturing the negative electrode for the battery according to the present invention is not particularly restricted, except for using the silicate used in the present invention as the negative electrode active material. Any known method of manufacturing the negative electrode can be employed as the method of manufacturing the negative electrode for the battery according to the present invention. The negative electrode for the battery according to the present invention can be generally manufactured by a method to be described hereinafter.

First, the silicate used in the present invention is granulated. The granulated silicate used in the present invention as the negative electrode active material is dispersed in an appropriate solvent together with the conductive material and the binding material, thereby to obtain a composition having a paste shape or a slurry shape. The composition thus obtained is referred to as a negative electrode mixture. Subsequently, the negative electrode mixture is coated on the negative electrode collector and then the negative electrode mixture is dried, thereby to obtain the negative electrode. After drying the negative electrode mixture, a press working is applied to the negative electrode as necessary, so that an electrode density of the negative electrode can be adjusted. A layer funning a part of the negative electrode other than a layer constituted by the negative electrode collector is referred to as a negative electrode active material layer. The negative electrode active material layer is constituted by the negative electrode mixture being dried to take a laminated form.

A content of the negative electrode active material in the negative electrode mixture on dry mass basis is not particularly restricted, but it can be 60-98.8 pts.mass.

The solvent in which the granulated silicate used in the present invention is dispersed is not particularly restricted. Examples of the solvent include: water; aqueous organic solvent such as a lower alcohol or a lower ketone; non-aqueous organic solvent such as N-methyl-2-pyrrolidone (NMP) or toluene; and the like.

The negative electrode mixture can be coated on the negative electrode collector by appropriately employing known methods using a coating device, such as for example, a slit coater, a die coater, a gravure coater or the like.

The negative electrode mixture coated on the negative electrode collector can be dried by appropriately employing known methods, such as for example, natural drying, hot air, low humidity air, vacuum, infrared, far infrared, electron beam and the like. These methods can be used alone or in combination.

The negative electrode mixture, after drying, can be pressed by appropriately employing known methods, such as for example, a roll pressing method or a flat plate pressing method. In this press working, upon adjusting the thickness of the electrode, the thickness of the negative electrode mixture can be measured with a film thickness measuring device and the negative electrode mixture can be pressed several times until a desired thickness is attained.

(Battery)

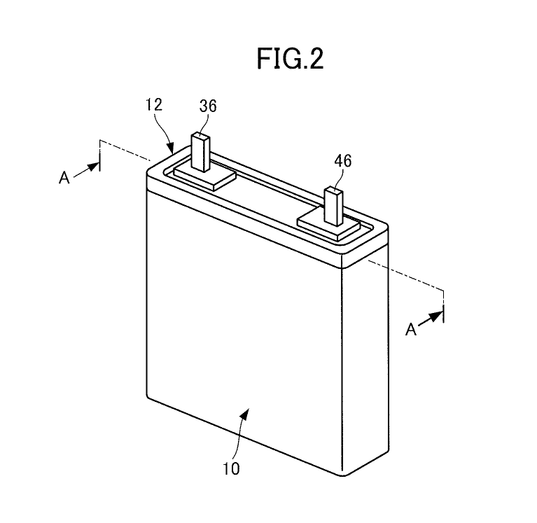

The battery according to the present invention will be explained hereinafter with reference to FIGS. 2-4. The battery according of the present invention comprises the above-mentioned negative electrode for the battery. A lithium-ion secondary battery 100 will be explained in detail as an embodiment of the battery according to the present invention. However, the battery according to the present invention is not restricted to the battery according to the present embodiment. Examples of the battery according to the present invention include a lithium-ion battery, a sodium-ion battery, a calcium-ion battery, a magnesium-ion battery and the like.

The lithium-ion secondary battery 100 according to the present embodiment comprises an electrode body, a non-aqueous electrolyte solution and a square-shaped battery case 10 having the electrode body and the non-aqueous electrolyte solution accommodated therein. A shape of the secondary battery is not particularly restricted, but material, shape, and size of the battery case and the electrode body can be appropriately selected in accordance with a usage and a capacity. The shape of the battery case can be, for example, a rectangular shape, a flat shape, a cylindrical shape and the like.

In FIGS. 2-4, members or portions having the same functions bear the same reference numerals and descriptions thereof may be omitted or simplified. The dimensional relationships (length, width, thickness, and the like) in each of FIGS. 2-4 do not reflect actual dimensional relationships.

In addition, for example, a construction and manufacturing method of an electrode body such as a wound structure and a laminated structure, a configuration and production method of a separator, or other general technical matters relating to a construction of a secondary battery can be construed to be design matters for a person skilled in the art that are based on the prior art in the pertinent technical field.

The lithium-ion secondary battery 100 according to the present invention is constituted mainly by a positive electrode sheet 30, a negative electrode sheet 40, a separator 50 and an electrolyte not shown. The positive electrode sheet 30 is a sheet-shaped positive electrode, while the negative electrode sheet 40 is a sheet-shaped negative electrode. The electrolyte is constituted by a non-aqueous electrolyte solution.

As shown in FIGS. 2-4, the lithium-ion secondary battery 100 is constituted by a wound electrode body 20, a non-aqueous electrolyte solution not shown, a battery case 10 having an opening portion 11 formed therein, and a cover body 12 for closing the opening portion 11 of the battery case 10. To be more specific, the lithium-ion secondary battery 100 is assembled in a process of: having the wound electrode body 20, together with the non-aqueous electrolyte solution not shown, accommodated in an inner portion of the battery case 10, being a flat box shape in response to the shape of the wound electrode body 20, through the opening portion 11; and then closing the opening portion 11 of the battery case 10 with the cover body 12. The cover body 12 has provided therein a positive electrode terminal 36 and a negative electrode terminal 46 both for external connection, so that a part of the positive electrode terminal 36 and the negative electrode terminal 46 protrude from a surface of the cover body 12. Inside the battery case 10, the other part of the positive electrode terminal 36 and the negative electrode terminal 46 are connected with an internal positive electrode terminal 35 and an inner negative electrode terminal 45, respectively.

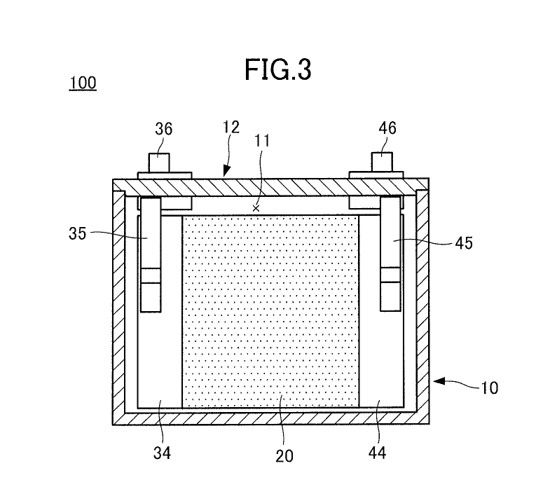

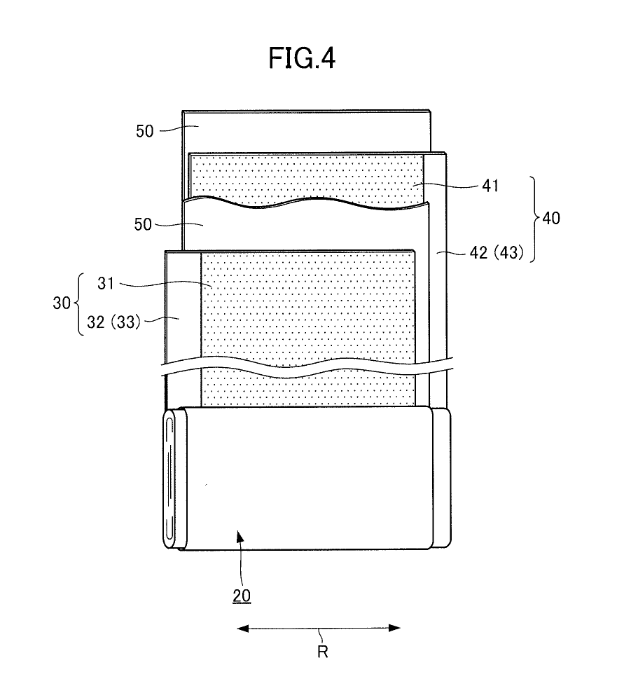

The wound electrode body 20 according to the present embodiment will be explained hereinafter with reference to FIGS. 3 and 4. As shown in FIG. 4, the wound electrode body 20 is constituted by the positive electrode sheet 30, the negative electrode sheet 40 and the separator 50 of a long sheet shape. The positive electrode sheet 30 is constituted by a long-sheet-shaped positive electrode collector 32 and a positive electrode active material layer 31 formed on the positive electrode collector 32. The negative electrode sheet 40 is constituted by a long-sheet-shaped negative electrode collector 42 and a negative electrode active material layer 41 formed on the negative electrode collector 42. In a winding axial direction R cross-sectional view, the positive electrode sheet 30 and the negative electrode sheet 40 are laminated through two sheets of the separator 50, in an order of the positive electrode sheet 30, the separator 50, the negative electrode sheet 40 and the separator 50. As shown in FIGS. 3 and 4, firstly the above-mentioned laminated material is wound around a shaft to be formed in a cylindrical shape, and then the cylindrical shape is pressed from sideways, thereby having the wound electrode body 20 finally formed in a flat shape.

As shown in FIGS. 3 and 4, the positive electrode sheet 30 has a positive electrode collector non-forming portion 33 formed in one end portion along the longitudinal direction thereof. The positive electrode collector non-forming portion 33 is not formed with the positive electrode active material layer 31 thereon or has the positive electrode active material layer 31 removed therefrom, so that the positive electrode collector 32 is exposed. Likewise, the negative electrode sheet 40 has a negative electrode collector non-forming portion 43 formed in the other end portion along a longitudinal direction thereof. The negative electrode collector non-forming portion 43 is not formed with the negative electrode active material layer 41 thereon or has the negative electrode active material layer 41 removed therefrom, so that the negative electrode collector 42 is exposed.

In the winding axial direction R cross-sectional view, the positive electrode collector non-forming portion 33 is laminated in one end portion of the winding axial direction R of the wound electrode body 20, in such a manner that the positive electrode collector non-forming portion 33 is protruding from the negative electrode sheet 40 and the separator 50, so that a positive electrode collector lamination portion 34 is formed. Likewise, in the winding axial direction R cross-sectional view, the negative electrode collector non-forming portion 43 is laminated in the other end portion of the winding axial direction R of the wound electrode body 20, in such a manner that the negative electrode collector non-forming portion 43 is protruding from the positive electrode sheet 30 and the separator 50, so that a negative electrode collector lamination portion 44 is formed.

The separator 50 has a width larger than a width of the laminated portion of the positive electrode active material layer 31 and the negative electrode active material layer 41, and smaller than a width of the wound electrode body 20. The separator 50 is arranged to be sandwiched between the laminated portions of the positive electrode active material layer 31 and the negative electrode active material layer 41, thereby to prevent an internal short-circuit caused by a contact between the positive electrode collector 32 and the negative electrode collector 42.

The separator 50, which is a sheet intervening between the positive electrode sheet 30 and the negative electrode sheet 40, is so positioned to be held in contact with each of the positive electrode active material layer 31 and the negative electrode active material layer 41. Further, the separator 50 plays a role of preventing a short-circuit caused by a contact between the positive electrode active material layer 31 and the negative electrode active material layer 41, and another role of forming a conductive path functioning as an electrically conducting path between the electrodes through impregnating the electrolyte such as the non-aqueous electrolyte solution into vacancies of the separator 50.

Further, the internal positive electrode terminal 35 is jointed to the positive electrode collector lamination portion 34 and is electrically connected to the positive electrode sheet 30 of the wound electrode body 20, while the internal negative electrode terminal 45 is jointed to the negative electrode collector lamination portion 44 and is electrically connected to the negative electrode sheet 40 of the wound electrode body 20. Jointing as mentioned above can be performed by appropriately employing known methods of jointing such as ultrasonic welding or resistance welding.

The lithium-ion secondary battery 100 according to the present embodiment can be assembled in a process of first having the obtained wound electrode body 20 accommodated in the battery case 10, thereafter injecting the non-aqueous electrolyte solution, and then having an injection hole constituted by the opening portion 11 sealed by the cover body 12.

(Construction of the Positive Electrode)

A positive electrode constituting the positive electrode sheet 30 will be explained hereinafter. The construction of the positive electrode according to the present embodiment is not particularly restricted, but known constructions of the positive electrode can be employed. The positive electrode according to the present embodiment is constructed to include the positive electrode active material, the conductive material, the binding material and the positive electrode collector, but the positive electrode according to the present invention is not particularly restricted thereto.

(Positive Electrode Active Material)

A positive electrode material capable of absorbing and discharging lithium can be used as the positive electrode active material used in the present invention. As the positive electrode active material used in the present invention, one or more kinds of substance conventionally used for lithium-ion secondary batteries can be used with no particular restriction.

Examples of the positive electrode active material include an oxide of spinel structure and an oxide of a layered structure. To be more specific, examples of the positive electrode active material include: a lithium-containing composite oxide including a lithium nickel-based composite oxide such as LiNiO₂, a lithium cobalt composite oxide such as LiCoO₂, a lithium-manganese composite oxide such as LiMn₂O₄, a lithium-magnesium-based composite oxide; and the like.

Further, an olivine-type lithium phosphate represented by a general formula LiMPO₄, wherein “M” represents at least one element of Co, Ni, Mn, and Fe, can be used as the positive electrode active material. Examples of the above-mentioned olivine-type lithium phosphate include LiFePO₄, LiMnPO₄ and the like.

As the positive electrode active material used in the sodium-ion secondary battery, for example, a sulfide containing the transition metal element, an oxide containing a sodium and the transition metal element can be used. To be more specific, a transition metal sulfide such as TiS₂, TiS₃, MoS₃, FeS₂, a sodium-manganese oxide such as Na_{(1-y)}Mn₂O₄ (hereinafter 0<y<1), a sodium-cobalt oxide Na_{(1-y)}CoO₂, a sodium-nickel oxide Na_{(1-y)}NiO₂, a sodium-vanadium oxide such as NaV₂O₃, transition metal oxide such as V₂O₅, and the like.

As the positive electrode active material used in the calium-ion secondary battery, for example, Ca₃Co₂O₆, Ca₃CoMnO₆ or the like can be used.

As the positive electrode active material used in the magnesium-ion secondary battery, for example, MgXMo₃S₄, graphite fluoride or the like can be used.

(Conductive Material, Binding Material, Thickening Agent)

As the conductive material, the binding material and the thickening agent, the substances used for the negative electrode as mentioned above can be used alone by one kind thereof or in combination of two or more kinds thereof.

(Positive Electrode Collector)

The positive electrode collector 32 is not particularly restricted, but, for example, aluminum or an alloy consisting mainly of aluminum can be used as the positive electrode collector 32. A shape of the positive electrode collector 32, which varies depending on the shape of the secondary battery or the like, is not particularly restricted, but the positive electrode collector 32 can take various forms such as rod-like shape, plate shape, sheet shape, foil shape and mesh shape.

In the present embodiment, the positive electrode collector 32 is constituted by a sheet-shaped aluminum positive electrode collector 32, so that it can be properly used for the lithium-ion secondary battery 100 provided with the wound electrode body 20. In the present embodiment, for example, an aluminum sheet having a thickness of approximately 10 μm-30 μm can be used.

(Method of Manufacturing the Positive Electrode)

The method of manufacturing the positive electrode is not particularly restricted, but any known method of manufacturing the positive electrode can be employed. The positive electrode can be generally manufactured by a method to be described hereinafter.

The positive electrode active material is dispersed in an appropriate solvent together with the conductive material and the binding material, thereby to obtain a composition having a paste shape or a slurry shape. The composition thus obtained is referred to as a positive electrode mixture. Subsequently, the positive electrode mixture is coated on the positive electrode collector and then the positive electrode collector having the positive electrode mixture coated thereon is dried, thereby to obtain the positive electrode. After drying the positive electrode mixture, a press working is applied to the positive electrode thus obtained as necessary, so that an electrode density of the positive electrode can be adjusted. A layer forming a part of the positive electrode other than a layer constituted by the positive electrode collector is referred to as a positive electrode active material layer. The positive electrode active layer is constituted by the positive electrode mixture being dried as mentioned above to take a laminated form.

A content of the positive electrode active material in the positive electrode mixture on dry mass basis is not particularly restricted, but it can be 80-95 pts.mass.

Here, the solvent in which the electrode is dispersed, the method of coating the mixture on the collector, the method of drying the mixture coated on the collector are similar to those described above in the method of manufacturing the negative electrode.

A content of the conductive material in the positive electrode mixture on dry mass basis can be appropriately selected according to a type or amount of the positive electrode active material. The content of the conductive material can be 1-10 pts.mass.

A content of the binding material in the positive electrode mixture on dry mass basis can be appropriately selected according to a type or amount of the positive electrode active material. The content of the binding material can be 1-5 pts.mass.

(Negative Electrode)

The construction and the method of manufacturing the negative electrode are as mentioned above. In the present embodiment, the negative electrode collector 42 is constituted by a sheet-shaped cupper negative electrode collector 42, so that it can be properly used for the lithium-ion secondary battery 100 provided with the wound electrode body 20. In the present embodiment, for example, a cupper sheet having a thickness of approximately 6 μm-30 μm can be used.

(Electrolyte)

The electrolyte is not particularly restricted, but any electrolyte conventionally used for lithium-ion secondary batteries can be used. In the present embodiment, a non-aqueous electrolyte solution is used. The non-aqueous electrolyte solution has a supporting salt in the non-aqueous solvent.

A lithium salt used as a supporting salt in a general lithium-ion secondary battery can be appropriately selected to be used as the supporting salt. The lithium salt is not particularly restricted, and examples include LiPF₆, LiBF₄, LiClO₄, LiAsF₆, Li(CF₃SO₂)₂N, LiCF₃SO₃ and the like. Among these, LiPF₆ is preferable. A concentration of the supporting salt in the non-aqueous electrolyte solution is not particularly restricted, but it can be, for example, 0.7˜1.3 mol/L. The supporting salt can be used alone by one kind thereof or in combination of two or more kinds thereof.

An organic solvent used as a supporting salt in a general lithium-ion secondary battery can be appropriately selected to be used as the non-aqueous solvent. The non-aqueous solvent is not particularly restricted, but examples include: carbonates such as ethylene carbonate (EC), diethyl carbonate (DEC), dimethyl carbonate (DMC), ethyl methyl carbonate (EMC), vinylene carbonate (VC) and propylene carbonate (PC); cyclic esters such as γ-butyrolactone; and the like. Among these, a mixed solvent of EC and DEC is preferable. These organic solvents can be used alone by one kind thereof or in combination of two or more kinds thereof.

Examples of the supporting salt of the electrolyte used in the sodium-ion secondary battery include NaClO₄, NaBF₄, (CF₃SO₂)₂NNa, (C₂F₅SO₂)₂NNa, NaCF₃SO₃, NaN(FSO₂)₂, NaC(CF₃SO₂)₃, NaPF₆, NaAsF₆, NaSbF₆, NaSiF₆, NaAlCl₄, NaAlF₄, NaSCN, NaCl, NaF, NaBr, Nal, NaAlCl₄ and the like.

Examples of the supporting salt of the electrolyte used in the calcium-ion secondary battery include Ca(BF₄)₂, Ca(CF₃SO₃)₂, Ca(PF₆)₂, Ca(ClO₄)₂, Ca(AsF₆)₂, Ca(SbF₆)₂, Ca[N(CF₂SO₂)₂]₂, Ca[N(CF₂F₄SO₂)₂]₂ and the like.

The same organic solvent as an organic solvent used in above-mentioned general lithium-ion secondary batteries can be used as the non-aqueous solvent of the electrolyte used in the sodium-ion secondary battery and the calcium-ion secondary battery.

As the electrolyte of the magnesium-ion secondary battery, a tetrahydrofuran (THF) solution of Mg(AlCl₂BuEt)₂, a THF solution of a halogenophenyl magnesium (C₆H₅MgX (X=Cl, Br)), a polymer gel electrolyte inclusive of C6H5MgX (X=Cl, Br) and polyethylene oxide (POE) and the like can be used.

(Separator)

The separator 50, which is a layer intervening between the positive electrode sheet 30 and the negative electrode sheet 40, takes a sheet shape in the present embodiment, so as to be positioned to be held in contact with each of the positive electrode active material layer 31 forming a part of the positive electrode sheet 30 and the negative electrode active material layer 41 forming a part of the negative electrode sheet 40. The separator 50 plays a role for preventing the short-circuit on the positive electrode sheet 30 and the negative electrode sheet 40 caused by the contact between the positive electrode active material layer 31 and the negative electrode active material layer 41, and another role for forming the conductive path functioning as an electrically conducting path between the electrodes through impregnating the electrolyte solution such as the non-aqueous electrolyte solution into vacancies of the separator 50.

The separator 50 is not particularly restricted, but known separator can be appropriately employed. For example, a micro-porous resin sheet, which is a porous sheet made of resin, can be used as the separator 50. For example, a porous polyolefin-based resin sheet such as a polyethylene (PE), a polypropylene (PP), and polystyrene can be used as the micro-porous resin sheet. Among these, a PE sheet, a PP sheet, and a multiple-layer structure sheet having a PP layer and a PE layer laminated thereon and the like are preferable. A thickness of the separator is not particularly restricted, but it can be, for example, 10 μm˜40 μm.

(Counter Electrode Lithium Evaluation)

In the present specification, a counter electrode lithium evaluation refers to an evaluation of a coin cell, which is a lithium-ion secondary battery constituted by an operation electrode using an evaluation active material, a reference/counter electrode using a lithium metal and an electrolyte using an electrolyte for a lithium-ion battery. The evaluation active material is the silicate used in the present invention. The coin cell is for example, a type 2032 coin cell.

Evaluation items include a charge capacity, a discharge capacity, a charge/discharge efficiency, a plateau potential at discharge time and the like. These evaluation items are generally obtained from a discharge curve plotted on a coordinate having a vertical axis for the potential and a horizontal axis for the discharge capacity or a discharge time.

The “plateau potential at discharge time” refers to: a potential of a portion of the discharge curve in which the potential is substantially constant so that the portion of the discharge curve is flat with respect to the horizontal axis; or a potential at a displacement point at which a straight line (a) and a straight line (b) intersect with each other, the straight line (a) having the same inclination as the inclination of the potential-capacity curve at a start of discharge, and the straight line (b) having a gentler inclination than the inclination of the potential-capacity curve at the start of discharge.

Generally, the plateau potential during discharging of the lithium titanate is set to 1.55V with respect to lithium.

As can be understood from the foregoing description, the counter electrode lithium evaluation refers to the evaluation of the lithium-ion secondary battery constituted by the operation electrode using the silicate used in the present invention as the negative electrode active material, and a counter electrode lithium constituting the reference/counter electrode. Any reference to “a potential with respect to” in this evaluation carries the same meaning as, for example, the notation “vs. Li/Li⁺”, “Li counter electrode time”, “lithium reference”, “with respect to the metal lithium potential” and the like.

Further, a counter electrode sodium evaluation can be conducted in a similar method by employing a sodium metal as the reference/counter electrode and an electrolyte for sodium ion battery as the electrolyte. Furthermore, a counter electrode calcium evaluation can be conducted in a similar method by employing a calcium metal as the reference/counter electrode and an electrolyte for calcium ion battery as the electrolyte. Still further, a counter electrode magnesium evaluation can be conducted in a similar method by employing a magnesium metal as the reference/counter electrode and an electrolyte for magnesium ion battery as the electrolyte.

The capacity of the negative electrode for the battery according to the present invention is not particularly restricted, but both of the charge capacity and the discharge capacity in the counter electrode lithium evaluation are preferably 200 mAh/g or higher at an initial charge time and at an initial discharge time.

The charge capacity at the initial charge time is more preferably 300 mAh/g or higher, and still more preferably 400 mAh/g or higher. The discharge capacity at the initial discharge time is more preferably 250 mAh/g or higher.

Therefore, to be specific, a preferable combination is such that in a case the discharge capacity at the initial discharge time is 200 mAh/g or higher or 250 mAh/g or higher, the charge capacity at the initial charge time is 200 mAh/g or higher, 300 mAh/g or higher or 400 mAh/g or higher.

The plateau potential at the time of discharge according to the present invention is not particularly restricted, but the plateau potential is preferably 1.5 V or lower at the initial charge time in the counter electrode lithium evaluation. The plateau potential at the initial charge time is more preferably 1 V or lower, still more preferably 0.8 V or lower, an most preferably 0.6 V or lower.

(Usage of the Battery)

The battery according to the present invention is the secondary battery using the negative electrode for the battery according to the present invention. Usage of the battery according to the present invention is not particularly restricted, however, for example, the battery can be used for a vehicle, a battery-mounted device or the like. Methods for mounting the battery according to the present invention on the vehicle or in the battery-mounted device can be construed to be design matters for a person skilled in the art that are based on the prior art in the technical field.

(Vehicle)

The present invention provides the vehicle in which the battery according to the present invention is used. The vehicle having the battery according to the present invention mounted thereon uses an electric energy of the secondary battery mounted thereon for at least a part of a driving energy of a driving source. The vehicle is not particularly restricted, but examples include electric vehicles, hybrid vehicles, plug-in hybrid vehicles, hybrid railway vehicles, electric forklifts, hybrid forklift, electric wheelchairs, electric assisted bicycles, electric scooters and the like.

(Battery-Mounted Device)

The present invention provides the battery-mounted device in which the battery according to the present invention is used. The battery-mounted device having the battery according to the present invention mounted therein uses an electric energy of the secondary battery mounted therein for at least a part of a driving energy. The battery-mounted device is not particularly restricted, but examples include: various driven portable electronic devices such as notebook computers, mobile telephones and video cameras; various battery-driven electric appliances, office equipments, industrial equipments, such as power tools, uninterruptible power supply (UPS) devices and capacitors; and the like.

Conventionally, the lithium titanate (Li₄Ti₅O₁₂) has been used in lithium-ion secondary batteries for high reliability use, as a negative electrode active material capable of absorbing and discharging lithium ion without varying a structure and size of crystal grids. However, a theoretical capacity of the lithium titanate is as low as 175 mAh/g even though the lithium titanate has a high molecular weight, due to the fact, as it is believed, that only three electrons react as shown in the following reaction formula: Li₄Ti₅O₁₂+3Li+3e⁻→Li₇Ti₅O₁₂.

In contrast, the silicate used in the present invention provides an extremely high charge/discharge capacity, in comparison with the lithium titanate. An estimation base on the charge capacity indicates occurrence of nine electron reactions in the silicate used in the present invention.

In the present invention, it is considered to be necessary that at least one species of transition metal element be included in M forming a part of the general formula AₚM₂₋ₚX₂O₆, in order to obtain the high capacity as mentioned above. Although the cause is indefinite, it can be estimated that if a transition metal is not included in M, a charge compensation is not properly conducted, so that the charge/discharge capacity is lowered as a result, thereby making it impossible to obtain a high charge/discharge capacity.

Further, use of the silicate used in the present invention can lower the charge potential, thereby making it possible to obtain a high voltage battery having a high battery voltage.

Therefore, the silicate used in the present invention can be called a high-capacity medium-potential negative electrode material, and the negative electrode according to the present invention can be called a high-capacity medium-potential negative electrode.

Further, the silicate used in the present invention is not only usable in the negative electrode for the lithium-ion secondary battery but also structured to include Ca, Na and Mg, so that the silicate used in the present invention can be estimated to be usable also in the negative electrode for the calcium-ion secondary battery, the negative electrode for the sodium-ion secondary battery and the negative electrode for the magnesium-ion secondary battery. Furthermore, the silicate used in the present invention can generally be constituted by the natural mineral, so that the material cost can be estimated to be lowered.

### EXAMPLES

The present invention will be explained hereinafter by examples and comparisons, but the present invention is not restricted thereto. Each of the aegirine, the esseneite and the augite used in the examples below constitutes the silicate mineral used in the present invention mentioned above.

<Evaluation as the Lithium-Ion Secondary Battery>

The silicate used in the present invention was evaluated as the negative electrode active material for the lithium-ion secondary battery based on the results of experiments to be explained hereinafter.

### Example 1

### Active Material Preprocessing

Aegirine (NaFeSi₂O₆) originated in Malawi was crushed in mortar for 60 minutes to obtain an active material.

[Electrode Assembly]

One milligram (1 mg) of the active material thus obtained was then mixed with N-methyl-2-pyrrolidone (NMP), in such a manner that a mass ratio of the active material, a conductive material (a carbon material) and polyvinylidene fluoride (PVDF) is 64:30:6, so that the negative electrode mixture in the slurry state was prepared. Subsequently, the negative electrode mixture thus prepared was coated on a cupper foil of 10 μm in thickness (manufactured by UACJ Foil Corporation, formerly Nippon Foil Mfg. Co., Ltd.) and dried. Next, the coated cupper foil was pressed so that the electrode density of the coated cupper foil in its entirety including the cupper foil and the negative electrode mixture layer was 1.1 mg/cm², and a portion of the pressed cupper foil was stamped out of the pressed cupper foil in a circular shape having a diameter of 16 mm, thereby to obtain the negative electrode.

[Battery Assembly]

A type 2032 coin cell was assembled as a lithium-ion secondary battery for counter electrode lithium evaluation. The 2032 type coin cell was assembled using the negative electrode obtained as described above as the operating electrode, the counter electrode lithium as the reference/counter electrode, a solution of LiPF₆ dissolved by 1M concentration in a solvent mixed with ethylene carbonate (EC) and diethyl carbonate (DEC) by volume ratio of 3:7 as the electrolyte solution, and a polyethylene separator as the separator.

[Electrochemical Characteristic Evaluation (Counter Electrode Lithium Evaluation)]

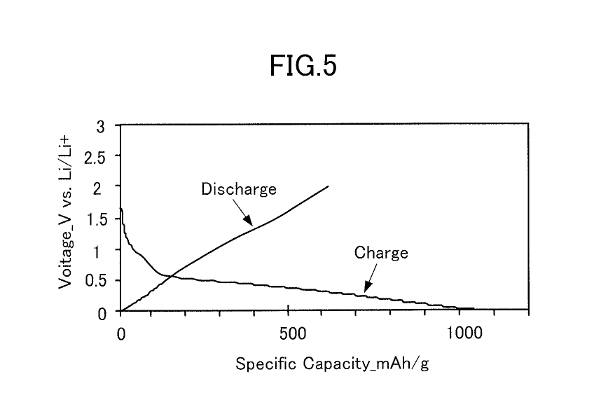

As for charging, Li was inserted into the negative electrode up to 0.01V at 0.1 C (1 C=an electric current value at which full charge/discharge can be performed in one hour), then thereafter as for discharging, Li was desorbed from the negative electrode up to 2.0V, thereby to determine the charge capacity, the discharge capacity, the charge/discharge efficiency and the plateau potential at the discharge time by using the coin cell obtained as described above. The experiment results are shown in FIG. 5 and Table 1.

The plateau potential at the discharge time determined from FIG. 5 was higher than 0.5V and lower than 0.6V.

The charge capacity and the discharge capacity (mAh/g) denote the charge capacity and the discharge capacity, respectively, per mass of active material, determined by a calculation formula: “charge capacity or discharge capacity of cell/mass of active material”. A charge at an initial time and a discharge at an initial time are referred to as an initial charge and an initial discharge, respectively, both of which are collectively referred to as an initial charge/discharge.

A charge/discharge efficiency (%) was determined by a calculation formula: “discharge capacity (mAh/g)/charge capacity (mAh/g)×100”.

In a potential-capacity curve plotted in a two dimensional coordinate having a vertical axis representing a potential (V) with respect to lithium and a horizontal axis representing the discharge capacity (mAh/g), the plateau potential (V) of the potential-capacity curve at the discharge time was detellnined as: a potential of a portion of the discharge curve in which the potential is substantially constant so that the portion of the discharge curve is flat with respect to the horizontal axis; or a potential at a displacement point at which a straight line (a) and a straight line (b) intersect with each other, the straight line (a) having the same inclination as the inclination of the potential-capacity curve at a start of discharge, and the straight line (b) having a gentler inclination than the inclination of the potential-capacity curve at the start of discharge.

The straight line (b) is determined by following the potential-capacity curve from a lower potential side while the straight line (a) is determined by following the potential-capacity curve from a higher potential side, thereby to determine the displacement point as a crossing point of the straight lines (a) and (b).

### Example 2

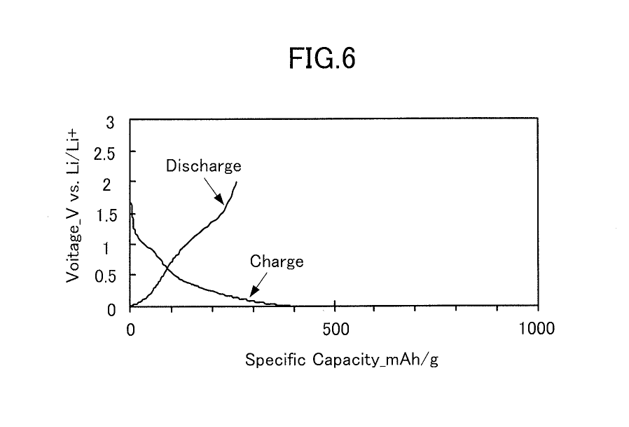

In this example, a coin cell was assembled in the same method as the method in the example 1 except for using esseneite (CaFeAlSiO₆) originated in Czech Republic instead of the aegirine. The charge capacity, the discharge capacity, the charge/discharge efficiency and the plateau potential in the discharge time of the coin cell thus assembled were determined in the same method as the method in the example 1. The experiment results are shown in FIG. 6 and Table 1.

The plateau potential at the discharge time determined from FIG. 6 was higher than 0.5V and lower than 0.6V.

### Example 3

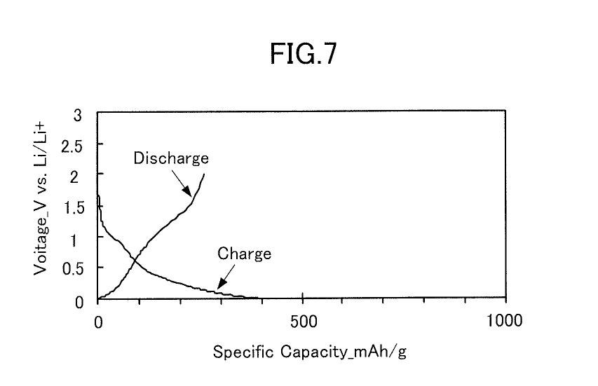

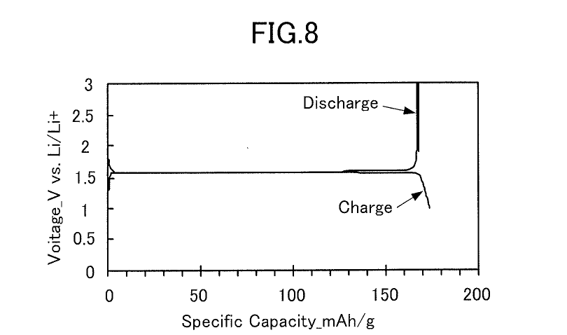

In this example, a coin cell was assembled in the same method as the method in the example 1 except for using augite [Ca(Mn, Fe, Zn)Si₂O₆] originated in the United States of America instead of the aegirine. The charge capacity, the discharge capacity, the charge/discharge efficiency and the plateau potential in the discharge time of the coin cell thus assembled were determined in the same method as the method in the example 1. The experiment results are shown in FIG. 7 and Table 1.

The plateau potential at the discharge time determined from FIG. 7 was higher than 0.4V and lower than 0.5V.

[Comparison Instance]

A coin cell was assembled in the same method as the method in the example 1 except for using a commercially available negative electrode using lithium titanate (Li₄Ti₅O₁₂) instead of the negative electrode using the aegirine.

[Electrochemical Characteristic Evaluation (Counter Electrode Lithium Evaluation)]

Using the coin cell obtained as described above, Li was inserted into the negative electrode up to 1.0V at 0.1 C (1 C=an electric current value at which full charge/discharge can be performed in one hour) for charging, then thereafter Li was desorbed from the negative electrode up to 3.0V for discharging, thereby to determine the charge capacity, the discharge capacity, the charge/discharge efficiency and the plateau potential at the discharge time in the same method as explained in the example 1. The experiment results are shown in FIG. 8 and Table 1.

The plateau potential at the discharge time determined from FIG. 8 was higher than 1.5V and lower than 1.6V.

TABLE 1

| | Negative | | | Charge/ |
|---|---|---|---|---|
| | Electrode | Charge | Discharge | Discharge |
| | Active | Capacity | Capacity | Efficiency |
| | Material | (mAh/g) | (mAh/g) | (%) |
| Example 1 | Aegirine | 1151 | 614 | 53 |
| | (NaFeSi₂O₆), | | | |
| Example 2 | Esseneite | 1000 | 440 | 44 |
| | (CaFeAlSiO₆) | | | |
| Example 3 | Augite | 481 | 262 | 54 |
| | [Ca(Mn, Fe, | | | |
| | Zn)Si₂O₆]. | | | |
| Comparison | Lithium Titanate | 174 | 168 | 97 |
| Instance | (Li₃Ti₄O₁₂) | | | |

As shown in Table 1, the charge capacity and the discharge capacity in the examples 1-3 were higher than the same in the comparison instance. This means that the batteries using the negative electrode according to the present invention (examples 1-3) showed higher capacities than the battery not using the negative electrode according to the present invention (comparison instance). This experiment result demonstrates that the silicate used in the present invention has an excellent charge/discharge characteristic.

As can be understood from FIGS. 5-8, the plateau potentials (the vicinity of 0.4-0.6V) in the examples 1-3 were sufficiently low in comparison with the plateau potential (higher than 1.5V and lower than 1.6V) in the comparison instance. This means that the negative electrode according to the present invention (examples 1-3) can lower the discharge potential in comparison with the comparison instance. This experiment result demonstrates that the use of the negative electrode according to the present invention makes it possible to obtain a high-voltage battery having a high battery voltage.

<Evaluation as a Sodium-Ion Secondary Battery>

The silicate used in the present invention as a negative electrode active material for a sodium-ion secondary battery was evaluated through the experiment described hereinafter.

### Example 4

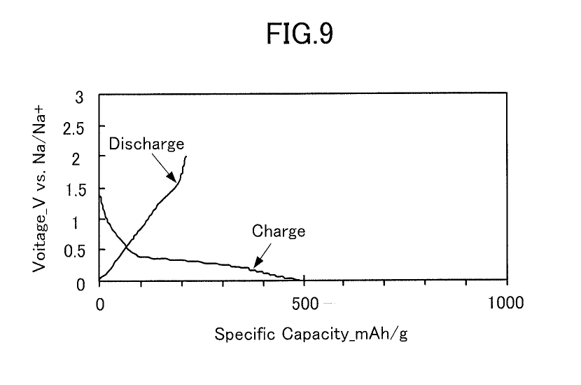

In this example, a coin cell was assembled in the same method as the method in the example 1, except for using the counter electrode sodium instead of the counter electrode lithium as the positive electrode and using a solution of NaPF₆ dissolved by 1M concentration in a solvent mixed with EC and DEC by volume ratio of 1:1 instead of the solution of LiPF₆ dissolved by 1M concentration in a solvent mixed with EC and DEC by volume ratio of 3:7 as the electrolyte solution. The counter electrode sodium evaluation of the coin cell thus assembled was conducted in the same method as the method in the example 1, thereby to determine the charge capacity, the discharge capacity, the charge/discharge efficiency and the plateau potential in the discharge time. The experiment results are shown in FIG. 9 and Table 2.

### Example 5

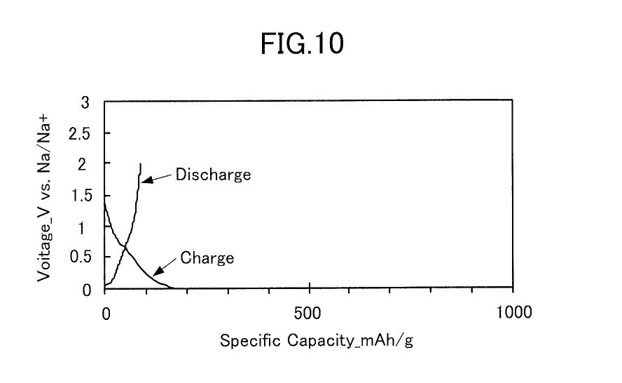

In this example, a coin cell was assembled in the same method as the method in the example 4 except for using augite [Ca(Mn, Fe, Zn)Si₂O₆] originated in the United States of America instead of the aegirine. The charge capacity, the discharge capacity, the charge/discharge efficiency and the plateau potential in the discharge time of the coin cell thus assembled were determined in the same method as the method in the example 4. The experiment results are shown in FIG. 10 and Table 2.

TABLE 2

| | Negative | | | Charge/ |
|---|---|---|---|---|
| | Electrode | Charge | Discharge | Discharge |
| | Active | Capacity | Capacity | Efficiency |
| | Material | (mAh/g) | (mAh/g) | (%) |
| Example 4 | Aegirine | 555 | 221 | 38 |
| | (NaFeSi₂O₆), | | | |
| Example 5 | Esseneite | 203 | 89 | 44 |
| | (CaFeAlSiO₆) | | | |

### EXPLANATION OF REFERENCE NUMERALS

10 . . . battery case
11 . . . opening portion
12 . . . cover body
20 . . . wound electrode body
30 . . . positive electrode sheet
31 . . . positive electrode active material layer
32 . . . positive electrode collector
33 . . . positive electrode collector non-forming portion
34 . . . positive electrode collector lamination portion
35 . . . internal positive electrode terminal
36 . . . positive electrode terminal
40 . . . negative electrode sheet
41 . . . negative electrode active material layer
42 . . . negative electrode collector
43 . . . negative electrode collector non-forming portion
44 . . . negative electrode collector lamination portion
45 . . . internal negative electrode terminal
46 . . . negative electrode terminal
50 . . . separator
100 . . . lithium-ion secondary battery

1. A negative electrode for a secondary battery, the negative electrode comprising a silicate having a pyroxene structure and represented by a general formula AₚM₂₋ₚX₂O₆, wherein
“A” represents at least one species selected from among a group consisting of Na, Ca, Fe, Zn, Mn and Mg,
“M” represents at least one species selected from among a group consisting of transition metal elements, Al and Mg, where one of the transition metal elements being an indispensable element of “M”,
“A” and “M” represent same elements or different elements,
“p” represents a number satisfying 0<p<2,
“X₂” represents Siₜ or Al_{q}Si_{2-q}, and
“q” represents a number satisfying 0<q<2.

2. The negative electrode for the secondary a battery as set forth in claim 1, wherein both of a charge capacity and a discharge capacity in a counter electrode lithium evaluation are 200 mAh/g or higher at an initial charge time and at an initial discharge time.

3. The negative electrode for the secondary battery as set forth in claim 1, wherein a plateau potential at the initial charge time in the counter electrode lithium evaluation is 1.5 V or lower.

4. The negative electrode for the secondary battery as set forth in claim 1, wherein the silicate is one substance selected from among a group consisting of aegirine (NaFeSi₂O₆), esseneite (CaFeAlSiO₆) and augite [Ca(Mn, Fe, Zn)Si₂O₆].

5. The negative electrode for the secondary battery as set forth in claim 4, which includes two layers of a cupper foil and a negative electrode mixture, the two layers formed by coating the negative electrode mixture in a slurry state on the cupper foil and drying thereafter, wherein the negative electrode mixture in the slurry state is prepared by obtaining an active material through crushing the one substance and mixing the active material with N-methylpyrrolidone (NMP), in such a manner that a mass ratio of the active material, a conductive material (a carbon material) and polyvinylidene fluoride (PVDF) is 64:30:6.

6. A secondary battery comprising the negative electrode for the secondary battery as set forth in claim 1.

7. A vehicle having the secondary battery as set forth in claim 6 mounted thereon.

8. A battery-mounted device having the secondary battery as set forth in claim 6 mounted therein.
